(19) United States
(12) Patent Application Publication
(10) Pub. No.: US 2025/0170647 A1
(43) Pub. Date: May 29, 2025

(54) PROCESS FOR MANUFACTURING GREEN PIECES MADE OF CERAMIC AND/OR METALLIC MATERIAL BY THE TECHNIQUE OF ADDITIVE MANUFACTURING

(71) Applicant: S.A.S 3DCERAM-SINTO, Bonnac la Cote (FR)

(72) Inventors: Christophe CHAPUT, Le Palais-sur-Vienne (FR); Eric LOURADOUR, Limoges (FR); Stéphane SCHWEIZER, FEYTIAT (FR)

(21) Appl. No.: 18/956,963

(22) Filed: Nov. 22, 2024

(30) Foreign Application Priority Data
Nov. 23, 2023 (FR) 2312971

(51) Int. Cl. B22F 10/12; B22F 10/43; B22F 12/33; B33Y 10/00; B33Y 30/00

(52) U.S. Cl. CPC B22F 10/12; B22F 10/43; B22F 12/33; B33Y 10/00; B33Y 30/00

(57) ABSTRACT

According to the present invention, before applying the first layer: the building platform is covered with a support sheet capable of being pressed against it, forming a rigid and fixed surface for receiving successive layers capable of retaining on it the successive layers formed; and the said support sheet is pressed against the said construction platform by suction; the green piece formed using the technique of additive manufacturing; and once the green piece has been formed in this way, the suction is removed in order to detach from the said platform the said support sheet on which the green piece is located with the part of the photocurable composition which has not been cured; the uncured part of the photocurable composition is removed; and the green piece is unhooked from the support sheet, characterised in that the support sheet is a polymeric sheet having a thickness of 0.05 to 5 mm and a flatness of less than 70% of the thickness of a layer, preferably less than 40% of the thickness of a layer, said support sheet being deformable to allow, once the suction has been removed, the green piece to be unhooked therefrom by applying a stress to said sheet so as to deform it in order to release the green piece.

This application claims priority to FR Patent Application No. 2312971 filed Nov. 23, 2023, the entire contents of which are hereby incorporated by reference.

The present invention relates to a process for manufacturing, by the technique of additive manufacturing, a green piece made of at least one material chosen from ceramic materials and metallic materials.

The technique of additive manufacturing, also called stereolithography, generally comprises the following steps to obtain these green pieces:
a computer model of the piece to be manufactured is built by computer-aided design, the dimensions of which model are slightly larger than those of the piece to be manufactured in order to allow for shrinkage of the ceramic or metallic material during manufacture of the piece; and
the piece is manufactured using the technique of additive manufacturing, in which:
   a first layer of a photocurable composition comprising at least one ceramic or metallic material, at least one photocurable monomer and/or oligomer, at least one photoinitiator and, where appropriate, at least one plasticizer and/or at least one solvent and/or at least one dispersant, is formed on a rigid support;
   the first layer of the photocurable composition is cured by irradiation (by laser scanning of the free surface of the said layer or by a diode projection system) in accordance with a pattern defined on the basis of the model for the said layer, forming a first stage;
   a second layer of the photocurable composition is formed on the first layer;
   the second layer of the photocurable composition is cured by irradiation in accordance with a pattern defined for the said layer, forming a second stage, this irradiation being carried out as for the first layer;
   optionally, the above steps are repeated to obtain the piece in its green state.

Then, as mentioned above, to obtain the finished piece, the green piece is cleaned to remove the uncured composition; the cleaned green piece is debinded; and the cleaned and debinded green part is sintered to obtain the finished piece.

In a manufacturing by pasty process, the photocurable composition is in the form of a paste whose viscosity may vary especially from 1 Pa·s to infinity for a zero shear rate, and the rigid support is a working platform supporting the different layers of the piece being built and the paste, and each of the layers is generally formed by lowering the working platform and spreading a predefined thickness of paste. A supply of paste is stored in tanks that are automatically emptied of a predefined amount of paste at each layer by means of a piston. This creates a bead of paste to be spread on the top layer of the piece being manufactured, which will have been previously lowered by the working platform. Each layer is generally spread by scraping with a scraping blade that sweeps across the working surface of the working platform, for example by advancing in a straight horizontal direction.

Another manufacturing by pasty/creamy process is described in patent application FR3116461, which uses an applicator system with a supply of suspension fed from an external reservoir, the layers being stacked in a tray that fills with suspension each time a layer is formed.

In manufacturing by liquid process, the photocurable composition is in the form of a low-viscosity suspension.
In a first embodiment of the manufacturing by liquid process, the rigid support is a platform which is lowered into a bath of the photocurable suspension to cover it with a layer of the said suspension, which is then cured by irradiation as indicated above. On this first layer, each of the other layers is then formed successively by lowering the platform step by step into the bath so that the upper stage of the piece being formed is lowered below the free surface of the photocurable suspension to form the layer in question, which is then irradiated.
In a second embodiment of the manufacturing by liquid process, the photocurable suspension is contained in a tank with a transparent bottom for irradiation, and the piece is held on a rigid support which is a platform raised step by step. A base layer is cured first, then the platform is raised one step to allow the suspension to form a new layer which is then cured, the operation being repeated for each layer.
In a third embodiment of the manufacturing by liquid process, the photocurable suspension is spread in a layer on a transparent film for irradiation, the film being capable of being unwound horizontally. The piece is formed on a rigid platform which is lowered to come into contact with the layer which is cured by irradiation through the film. A new segment of film coated with a new photocurable layer is then unwound and the operation is repeated until the piece is complete.

It is important that there is a good bond between the construction surface, i.e. the rigid working platform (the upper face of the working platform in the case of the paste process and the abovementioned first embodiment of the liquid process, respectively, and the lower face of the platform in the case of the second and third embodiments of the liquid process, and the piece that is built by stacking the layers.

A support is therefore placed between the rigid working platform and the piece under construction.

The choice of the support for the construction of the piece is crucial both for printing the piece and for recovering it. Indeed the support must meet several conflicting requirements:
to adhere sufficiently to the rigid working platform to guarantee the stability of the pieces;
to be sufficiently flat to allow thin layers to be printed;
to be easily detachable from the rigid working platform after printing; and
to make it easier to peel off the green piece so as not to damage it after printing.

Ceramic parts are currently printed by stereolithography on a magnetic support placed on the construction platform and held in place by magnetisation. While this system provides very good adhesion to the working platform, it does not meet the other three constraints set out above for thin-walled pieces, typically less than 1 mm, or pieces constructed in thin layers, typically 25 to 30 μm thick.

The flatness of magnetic supports is of the order of 50 μm, which is insufficient for construction in thin layers with a thickness of 25 to 30 μm. Furthermore, a lack of flatness means irregular adhesion to the support depending on the position of the pieces on the platform.

In addition, the rigidity of magnetic supports and their roughness make it difficult to detach the support from the platform and the pieces from the support. Thin-walled pieces run a high risk of damage during the detaching phase, making them unusable.

The difficulty of detaching thin-walled pieces also means that the number of pieces that can be printed at the same time on the same printer has to be reduced, which reduces productivity.

To solve this problem, the applicant company sought a solution that would enable thin-layered and thin-walled pieces to be built without damage to the pieces during the detaching phase and with optimum charging of the construction platform.

To this end, the object of the present invention is a process for manufacturing, by the technique of additive manufacturing, a green piece made of at least one material chosen from ceramic materials and metallic materials,

process according to which layers based on a photocurable composition comprising the said ceramic and metallic material or materials in the pulverulent state and an organic part comprising at least one photocurable monomer and/or oligomer and at least one photoinitiator are successively cured by irradiation in a pattern defined for each layer, the first layer being formed on a construction platform, and each other layer being formed and then cured in contact with the preceding layer,
process by which:
before applying the first layer:
   the building platform is covered with a support sheet capable of being pressed against it, forming a rigid and fixed surface for receiving successive layers capable of retaining on it the successive layers formed; and
   the said support sheet is pressed against the said construction platform by suction;
the green piece is formed using the technique of additive manufacturing; and
once the green piece has been formed in this way, the suction is removed in order to detach from the said platform the said support sheet on which the green piece is located with the part of the photocurable composition which has not been cured;
the uncured part of the photocurable composition is removed; and
the green piece is unhooked from the support sheet,
   said support sheet being deformable to allow, once the suction has been removed, the green piece to be unhooked therefrom by applying a stress to said sheet so as to deform it in order to release the green piece,
   characterised in that the support sheet is a polymeric sheet having a thickness of 0.05 to 5 mm and a flatness of less than 70% of the thickness of a layer, preferably less than 40% of the thickness of a layer, and that the construction platform has a roughness Ra of 0.4 to 3.2 μm.

The flatness of the support sheet can be defined as the difference in height between the lowest point of the sheet and its highest point, when the sheet is placed on a vertical support.

For example, in the case of the construction of a piece using layers with a thickness of between 25 and 30 μm, the flatness of the support sheet must be less than 17.5 μm, preferably less than 10 μm. For example, it may have a flatness of 8 μm.

The support sheet can have a Young's modulus of 2.5 to 80 GPa, preferably 2.5 to 15 GPa. The Young's modulus is measured in accordance with ISO-527; it is a measure of flexibility in the case of deformation applied in the direction perpendicular to the support sheet.

The support sheet can be a biaxially oriented polyethylene terephthalate sheet, a polyetherimide sheet, a polyamide sheet or a polyolefin sheet.

A photocurable composition of semi-liquid consistency can be used, which is spread layer by layer on the building platform, the layers being irradiated from above,

or a suspension photocurable composition can be used, the platform being lowered step by step into the suspension to form the successive layers irradiated from above, or the platform being arranged at a distance corresponding to the thickness of a layer of the bottom of a photocurable composition reservoir with a transparent bottom for irradiation and raised for each layer formation, the layers being irradiated from below in each case; or
in each layer formation the platform comes into contact with a suspension layer applied to a segment of a transparent film which is unrolled horizontally to present a new segment for each layer formation, the layers being each time irradiated from below.

Photocurable composition of semi-liquid consistency means a suspension with a viscosity of between 0.5 and 100 Pa·s over a range of shear rates of between 1 and 20 s⁻¹. The viscosity is measured on a cone/plane rheometer (model RM200 CP4000 Plus from Lamy Rheology), temperature 22° C., pre-shear at 1 s S⁻¹ for 60 s, viscosity 25range 1 to 20 s⁻¹.

The construction platform may be a flat perforated or porous plate made of a rigid material, such as ceramic, metal or plastic, the free face of which is covered by the support sheet and which is connected, by its opposite face, to a vacuum generating device, such as a vacuum pump or a vacuum generator, which vacuum generating device is put into operation in order to press the support sheet against the free face of the platform, forming the rigid and fixed surface for receiving the successive layers of photocurable composition, and which is put out of operation in order to detach the said support sheet from the said platform.

In particular, a perforated plate can be used, the perforations of which can take the form of holes and slots connected to the vacuum generating device, arranged to ensure that the support sheet is plated when the said pump or generator is in operation.

As a construction platform, use can be made of a receptacle, in particular made of metal or plastic, of flat shape, the bottom of which has perforations connected to a vacuum generating device, such as a vacuum pump, and which receives a grid, in particular made of metal, the support sheet being applied to the free edge of the receptacle and to the grid, the said vacuum generating device being put into operation in order to press the said support sheet against the free edge of the receptacle and against the grid, forming the rigid and fixed surface for receiving the successive layers of photocurable composition, and being put out of operation in order to detach the said support sheet from the said platform.

The construction platform can have a parallelism of 0.002 to 0.1% of the width of the construction platform.

A vacuum of 13.33 Pa-10⁻¹⁰ Pa (0.133 mbar-10⁻¹² mbar) can be generated.

The present invention also relates to a machine for the manufacturing, by the technique of additive manufacturing, of green pieces made of a material chosen from ceramic materials and metallic materials, in which layers based on a photocurable composition comprising the at least one material in the pulverulent state and an organic part comprising at least one photocurable monomer and/or oligomer and at least one photoinitiator are successively cured by irradiation in a pattern defined for each layer, the first layer being formed on a construction platform, and each other layer being formed and then cured on the preceding layer,

the machine comprising means for sucking against the said construction platform a support sheet intended to cover it before the first layer is produced, forming a surface for receiving the successive layers, capable of retaining on it the successive layers formed, the said suction means being capable of being deactivated in order to detach from the said platform the said support sheet on which the green piece is located with the part of the photocurable composition which has not been cured,
the construction platform being a grooved flat plate made of a rigid material, such as ceramic, metal or plastic, the free face of which is covered by the support sheet and which is connected, by its opposite face, to the suction means, said support sheet being deformable to allow, once the suction has been removed, the green piece to be unhooked therefrom by applying a stress to said sheet so as to deform it in order to release the green piece,
said machine also comprising means for irradiating successive layers,
characterised in that the construction platform has a roughness Ra of 0.4 to 3.2 μm and a parallelism of 0.002 to 0.1% of the width of the construction platform; and the support sheet is a polymeric sheet having a thickness of 0.05 to 5 mm and a flatness of less than 70% of the thickness of a layer, preferably less than 40% of the thickness of a layer.

The roughness is measured in accordance with ISO 4288, scanning length Lt=5.600 mm (0.800×5), scanning length corresponding to the length of the measurement range for the points used to assess roughness, roughness Ra, arithmetic mean deviation of points scanned by a roughness meter relative to an origin. The parallelism of the construction platform is the distance between the two closest points and two furthest points of the two surfaces making up the construction platform.

To better illustrate the object of the present invention, a particular embodiment is described below, by way of illustration and not as a limitation, with reference to the appended drawing.

On this drawing:

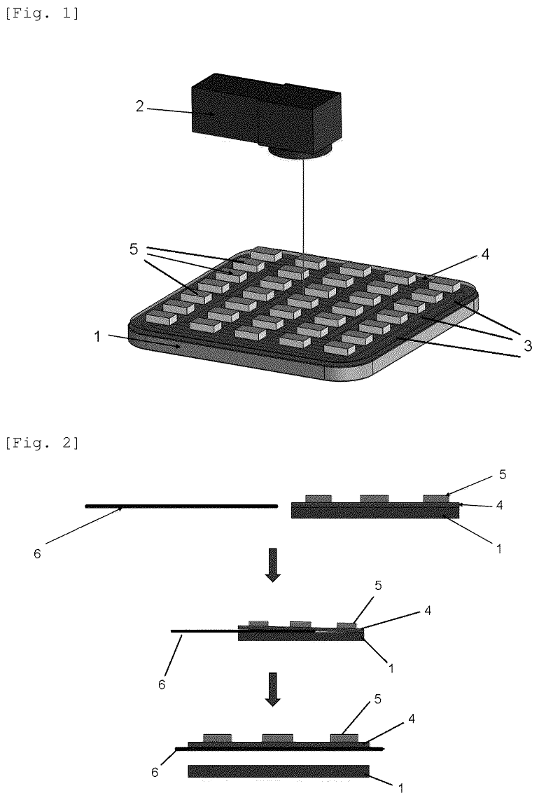

FIG. 1 is a perspective view of the construction platform and support sheet on a stereolithography machine.

FIG. 2 is a schematic view of the steps involved in inserting a release aid sheet between the construction platform and the support sheet.

The stereolithography machine is a conventional prior art machine, of which only the platform will be described in more detail below. FIG. 1 shows t the construction platform 1 used in the present invention. A conventional laser irradiation means 2 is used to irradiate the successive layers.

This platform 1 has a plurality of grooves 3. A support sheet 4 is arranged on it, said support sheet being a biaxially oriented polyethylene terephthalate sheet.

The support sheet 4 has a thickness of 190 μm, a flatness of 8 μm and a Young's modulus of 4.5 GPa.

It is possible to build a plurality of pieces 5 on the support sheet 4.

Before the pieces are built, the support sheet 4 is arranged on the construction platform 1 and the air between the platform 1 and the support sheet 4 is sucked in through the grooves 3 using a closed-loop venturi vacuum generating system. In this way, during construction of the pieces 5, the support sheet 4 is held firmly on the platform 1, ensuring the stability of the pieces 5.

Once the pieces 5 have been built, the vacuum is stopped, allowing the support sheet 4 to be easily peeled off the platform 1.

In the case of building a piece in a top-down system, where the pieces being built are illuminated from above and the construction platform is lowered as the pieces are built, it is possible to use a release aid sheet to make it even easier to release the support sheet from the construction platform. This is illustrated in FIG. 2.

A release aid sheet 6 is provided, which is a polyvinyl chloride sheet with a Young's modulus of 4.2 GPa and a thickness 4 mm greater than that of the support sheet 3.

Firstly, after stopping the vacuum, the release aid sheet 6 is placed close to the construction platform 1 on which the support sheet 4 is placed and on which the pieces 5 have been constructed.

The support sheet 4 is first lifted slightly from the construction platform 1 so that the edge of the release aid sheet 6 is positioned between the platform 1 and the support sheet 4. The release aid sheet 6 is then gradually slid between the support sheet 4 and the construction platform 1 as shown in the central drawing in FIG. 2.

Once the release sheet 6 has been fully inserted between the support sheet 4 and the construction platform 1, the assembly of pieces 5, support sheet 3 and release sheet 6 can be lifted.

This makes it easier to remove the support sheet 4 from the platform 1. The greater thickness of the release aid sheet 6 also makes it easier to handle the assembly formed by the constructed pieces 5, the support sheet 4 and the release aid sheet 6 in order to remove the pieces 5 more easily.

1. Process for manufacturing, by the technique of additive manufacturing, a green piece made of at least one from materials and metallic material chosen ceramic materials,
process according to which layers based on a photocurable composition comprising the at least one material in the pulverulent state and an organic part comprising at least one photocurable monomer and/or oligomer and at least one photoinitiator are successively cured by irradiation in a pattern defined for each layer, the first layer being formed on a construction platform, and each other layer being formed and then cured in contact with the preceding layer,
process by which:
before applying the first layer:
the building platform is covered with a support sheet capable of being pressed against it, forming a rigid and fixed surface for receiving successive layers capable of retaining on it the successive layers formed; and
the support sheet is pressed against the construction platform by suction;
the green piece is formed using the technique of additive manufacturing; and
once the green piece has been formed in this way, the suction is removed in order to detach from the platform the support sheet on which the green piece is located with the part of the photocurable composition which has not been cured;
the uncured part of the photocurable composition is removed; and
the green piece is unhooked from the support sheet, the support sheet being deformable to allow, once the suction has been removed, the green piece to be unhooked therefrom by applying a stress to the sheet so as to deform it in order to release the green piece,
wherein the support sheet is a polymeric sheet having a thickness of 0.05 to 5 mm and a flatness of less than 70% of the thickness of a layer, and that the construction platform has a roughness Ra of 0.4 to 3.2 μm.

2. The process according to claim 1, wherein the support sheet has a flatness of less than 40% of the thickness of a layer.

3. The process according to claim 1, wherein the support sheet has a Young's modulus of 2.5 to 80 GPa, preferably 2.5 to 15 GPa.

4. The process according to claim 3, wherein the support sheet has a Young's modulus of 2.5 to 15 GPa.

4. The process according to claim 1, wherein the support sheet is chosen from a biaxially oriented polyethylene terephthalate sheet, a polyetherimide sheet, a polyamide sheet and a polyolefin sheet.

5. The process according to claim 1, wherein the photocurable composition is chosen from a photocurable composition of semi-liquid consistency, which is spread layer by layer on the building platform, the layers being irradiated from above, and a suspension photocurable composition.

6. The process according to claim 5, wherein the platform is lowered step by step into the suspension to form the successive layers irradiated from above.

7. The process according to claim 5, wherein the platform is arranged at a distance corresponding to the thickness of a layer of the bottom of a photocurable composition reservoir with a transparent bottom for irradiation and raised for each layer formation, the layers being irradiated from below in each case.

8. The process according to claim 5, wherein in each layer formation the platform comes into contact with a suspension layer applied to a segment of a transparent film which is unrolled horizontally to present a new segment for each layer formation, the layers being each time irradiated from below.

9. The process according to claim 1, wherein a perforated or porous flat plate made of a rigid material is used as a construction platform, the free face of which is covered by the support sheet and which is connected, by its opposite face, to a vacuum generating device, which vacuum generating device is put into operation in order to press the support sheet against the free face of the platform, forming the rigid and fixed surface for receiving the successive layers of photocurable composition, and which is put out of operation in order to detach the support sheet from the platform.

10. The process according to claim 9, wherein a perforated plate is used, the perforations of which take the form of holes and slots connected to the vacuum generating device, arranged to ensure that the support sheet is plated when the pump or generator is in operation.

11. The process according to claim 1, wherein a receptacle of flat shape, the bottom of which has perforations connected to a vacuum generating device and which receives a grid, is used as construction platform, the support sheet being applied to the free edge of the receptacle and to the grid, the vacuum generating device being put into operation in order to press the support sheet against the free edge of the receptacle and against the grid, forming the rigid and fixed surface for receiving the successive layers of photocurable composition, and being put out of operation in order to detach the support sheet from the platform.

12. The process according to claim 1, wherein the construction platform has a parallelism of 0.002 to 0.1% of the width of the construction platform.

13. The process according to claim 1, wherein a vacuum of 13.33 Pa-10⁻¹⁰ Pa (0.133 mbar-10⁻¹² mbar) is generated.

14. Machine for the manufacturing, by the technique of additive manufacturing, of green pieces made of a material chosen from ceramic materials and metallic materials, in which layers based on a photocurable composition comprising the at least one material in the pulverulent state and an organic part comprising at least one photocurable monomer and/or oligomer at least one photoinitiator are successively cured by irradiation in a pattern defined for each layer, the first layer being formed on a construction platform, and each other layer being formed and then cured on the preceding layer,
the machine comprising means for sucking against the construction platform a support sheet intended to cover it before the first layer is produced, forming a surface for receiving the successive layers, capable of retaining on it the successive layers formed, the suction means being capable of being deactivated in order to detach from the platform the support sheet on which the green piece is located with the part of the photocurable composition which has not been cured,
the construction platform being a grooved flat plate made of a rigid material, the free face of which is covered by the support sheet and which is connected, by its opposite face, to the suction means,
the support sheet being deformable to allow, once the suction has been removed, the green piece to be unhooked therefrom by applying a stress to sheet so as to deform it in order to release the green piece,
the machine also comprising means for irradiating successive layers,
wherein the construction platform has a roughness Ra of 0.4 to 3.2 μm and a parallelism of 0.002 to 0.1% of the width of the construction platform; and
the support sheet is a polymeric sheet having a thickness of 0.05 to 5 mm and a flatness of less than 70% of the thickness of a layer.

15. The machine according to claim 14, wherein the support sheet has a flatness of less than 40% of the thickness of a layer
